(19) United States
(12) Patent Application Publication
(10) Pub. No.: US 2017/0229933 A1
(43) Pub. Date: Aug. 10, 2017

(54) Utilization of Magnetic Fields in Electric Machines

(71) Applicant: Ford Global Technologies, LLC, Dearborn, MI (US)

(72) Inventors: Franco Leonardi, Dearborn Heights, MI (US); Mark Allan Lippman, New Baltimore, MI (US); Michael W. Degner, Novi, MI (US)

(21) Appl. No.: 15/040,304

(22) Filed: Feb. 10, 2016

(51) Int. Cl. H02K 1/27; H02K 1/16

(52) U.S. Cl. CPC H02K 1/276; H02K 1/16

(57) ABSTRACT

An electric machine may include a plurality of stator sections each formed from one or more stator laminations stacked to form a stator. The stator may have windings arranged therein to form magnetic poles. The stator may surround a rotor. A diamagnetic or paramagnetic stator layer may be interposed between at least one adjacent pair of the stator sections.

### TECHNICAL FIELD

The present disclosure relates to magnetic field utilization for the stator of an electric machine.

### BACKGROUND

Electric machines typically employ a rotor and stator to produce torque. Electric current flows through the stator windings to produce a magnetic field. The magnetic field generated by the stator may cooperate with permanent magnets on the rotor to generate torque.

### SUMMARY

The rotor of an electric machine may be formed from a plurality of stacked rotor sections each formed from one or more rotor laminations. The sections may have skewed magnetic poles. A diamagnetic or paramagnetic rotor layer may be interposed between each adjacent pair of the sections that has skewed magnetic poles.

An electric machine stator may include a plurality of sections each formed from one or more stator laminations stacked to form a stator having windings arranged therein to form magnetic poles and surrounding a rotor. A layer may be interposed between an adjacent pair of the stator sections such that magnetic fields associated with the magnetic poles are aligned axially with corresponding magnetic fields from the rotor. The layer may be diamagnetic or paramagnetic.

The layer interposed between an adjacent pair of the stator sections and one of the rotor layers may be coplanar. The thickness of the layer interposed between an adjacent pair of the stator sections and one of the rotor layers may be same. The layer may be polytetrafluoroethylene. The thickness of the layer may be at least twice an airgap distance between the stator and rotor. The thickness may be less than four times the airgap distance.

### BRIEF DESCRIPTION OF THE DRAWINGS

FIG. 1A is a plan view of a rotor lamination;

FIG. 1B is a side view of the rotor section comprised of a stack of laminations for the electric machine shown in FIG. 1A;

FIG. 2A is a diagrammatic view of an electric machine with a rotor comprised of multiple poles, wherein flux lines are generated solely by a set of permanent magnets;

FIG. 2B is a diagrammatic view of an electric machine with a stator comprised of multiple energized windings, wherein the flux lines are generated solely by stator windings;

FIG. 3A is a perspective view of a machine rotor with a layer of matter with low magnetic permeability disposed between two skewed sections;

FIG. 3B is a perspective view of a pair of skewed, adjacent sections with a layer of matter with low magnetic permeability disposed on one of the sections;

FIG. 4 is a perspective view of a rotor with an ABBA configuration and a layer of matter between the AB sections;

FIG. 5 is a perspective view of a stator section;

FIG. 6 is a perspective view of a stator layer;

FIG. 7 is a perspective view of a stack of stator sections having stator layers disposed therein;

FIG. 8 is a perspective view of an electric machine having a stator and a rotor each having layers disposed therein; and

FIG. 9 is a section view of an electric machine having a rotor with an ABBA configuration having layers disposed between the AB sections and a stator surrounding the rotor having layers disposed between stator sections corresponding to the AB rotor sections.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Electric machines are characterized by an undesirable oscillation in the torque which is caused by harmonics present in the airgap flux and in the airgap permeance. Most electric machines, and in particular Permanent Magnet (PM) electric machines, are designed with rotor skew i.e. the laminations of active rotor material may be skewed, or staggered, along the axis of the rotor. Skewing may result in staggered permanent magnets and magnetic poles along the axis of the rotor. Skewed sections may cause an overall reduction in the average torque of the machine at all available speeds because the magnetic components are out of alignment, but skewing helps to minimize the harmonics, as discussed above.

For example, in the case of an 8-pole machine with two rotor sections, 48-slot stator, a typical skew angle is 3.75°. The skewing of the rotor is intended to produce a smoother mechanical torque than would otherwise be achieved using a rotor having aligned permanent magnets. Skewing may eliminate undesirable torque ripple caused by harmonics and many different skew angles may be used to achieve this result. Skew, however, does not contemplate two poles that are supposed to be aligned by design but because of manufacturing tolerances are not exactly aligned.

The average torque generated across all speeds of the electric machine may be reduced by skewing, in part, because magnetic field leakage may occur between skewed permanent magnets. This leakage may cause a small reduction in the available torque of the machine, and the leakage may not exist on non-skewed machines.

In addition, skewing may open a path for magnetic flux to leak from one lamination section to the adjacent one, without adding torque. Because magnetic fields generally follow the path of least resistance between opposite poles, the skewing and staggering of permanent magnets to reduce torque ripple may, consequently, cause additional magnetic flux leakage to occur. A section of the rotor may be comprised of one lamination or a plurality of laminations stacked together. The laminations of a section may be skewed relative to other laminations in the section or skewed collectively, relative to other sections of the rotor. This means a section of the rotor may be comprised of any number of laminations stacked together or a single block of composite material.

In order to maximize the magnetic field and resulting torque, the amount of active rotor material is typically maximized. Active rotor material may include a material capable of generating or carrying a magnetic or electric field. Maximization of this material, in theory, generates the most torque. Rotor and stator materials with the highest magnetic permeability are chosen. An introduction of materials without high magnetic permeability would presumably decrease the torque generation of the electric machine because the rotor would have wasted space (i.e., material that does not generate torque). Materials with high magnetic permeability may be generally referred to as ferromagnetic or ferrimagnetic. Presumably, a rotor composed of entirely active rotor material would create a more effective magnetic field than a rotor composed of partially active rotor material.

The introduction of a magnetically reluctant rotor layer or layers that is not active rotor material unexpectedly increases the utilization of permanent magnets in the rotor and increases the torque output of the electric machine. For example, the introduction of a reluctant layer with a thickness twice that of the airgap thickness between the stator and rotor may provide a specific torque increase greater than 0.25%. This amount, while seemingly nominal, can justifiably decrease the cost of electric machines because the improved utilization of permanent magnets may allow the size of the permanent magnets to be reduced. The increase in specific torque of the electric machine may depend on the thickness of the layer relative to the airgap and the electric current flowing through the stator.

A reluctant layer with low magnetic permeability may be inserted between adjacent sections having skewed magnetic poles. The layer may have a solid, liquid, or gas phase. The layer may redirect the magnetic field of the permanent magnets to a more desirable course and reduce leakage between permanent magnets. The layer may be a diamagnetic or paramagnetic material (e.g., water, copper, bismuth, superconductors, wood, air, polytetrafluoroethylene, or vacuum). Many different types of matter are capable of obtaining similar results and may fall into these designations. Materials with low magnetic permeability may be able to reduce the field leakage between sections with skewed poles or redirect the field into a more desirable course. Properly directed magnetic flux paths may increase the generated torque of the machine.

Permanent magnets may have multiple orientations when disposed on or within the sections. For example, permanent magnets may be arranged in a V-shape position providing poles at each V. Permanent magnets may also be oriented such that one of the magnetic poles is directed radially outward. The orientation and position of the magnets may have a direct effect on the electric machine's efficiency, and any skewed orientation or position may cause magnetic field leakage between the permanent magnets.

The poles of the permanent magnets may individually or cooperatively form magnetic poles of the rotor. Many rotors have a plurality of permanent magnets arranged to cooperate with the stator' s magnetic field in order to generate torque. The poles may be generated using permanent magnets, induced fields, excited coils, or a combination thereof.

Laminations are generally made of materials with high magnetic permeability. This high magnetic permeability allows magnetic flux to flow through the laminations without losing strength. Materials with high magnetic permeability may include iron, electrical steel, ferrite, or many other alloys. Rotors with laminations may also support an electrically conductive cage or winding to create an induced magnetic field. A rotor having four laminations or sections of laminations may have the sections configured in an ABBA orientation. The ABBA orientation means that the “A” sections are skewed to the same degree relative to the “B” sections. The rotor may have other lamination configurations (e.g., ABC or ABAB). In an ABBA configuration, the “A” sections may be referred to as outer sections. The “B” sections may be referred to as inner sections. The “A” sections may be skewed at the same degree and have aligned poles. The “B” sections may be skewed at the same degree and have aligned poles.

Introduction of a magnetically reluctant layer on the rotor reduces magnetic leakage between the skewed magnetic poles of the rotor. The rotor layer may, however, result in the corresponding stator material being underutilized. The amount of active stator material is also typically maximized to increase flux generated from the stator windings. With the introduction of a rotor layer, the underutilized stator material unnecessarily increases the weight of the electric machine. A stator layer may be introduced to match the separator layers of the rotor to ensure alignment between the active material of the stator and the active material of the rotor. Meaning, the rotor sections may be axially aligned and coplanar with corresponding stator sections. The layers of both the rotor and stator may increase the overall volume or displacement of the electric machine but reduce its weight by removing heavy underutilized magnetic material. The stator layer may be made of a material similar to the rotor layer. The stator layer may also have similar material properties as the rotor layer.

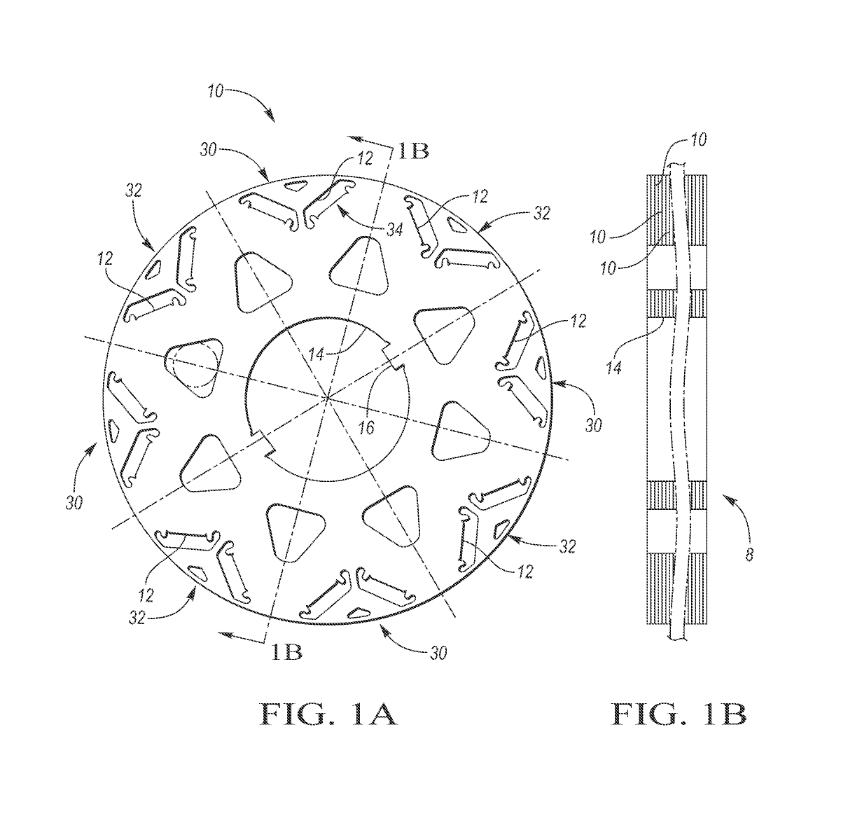

Referring now to FIG. 1A, a rotor section 10 for a rotor is shown. The rotor section 10 may define a plurality of pockets or cavities 12 adapted to hold permanent magnets. The center of the rotor section 10 may define a circular central opening 14 for accommodating a driveshaft with a keyway 16 that may receive a drive key (not shown). The cavities may be oriented such that the permanent magnets (not shown) housed in the pockets or cavities 12 form eight alternating magnetic poles 30, 32. It is well known in the art that an electric machine may have various numbers of poles. The magnetic poles 30 may be configured to be north poles. The magnetic poles 32 may be configured to be south poles. The permanent magnets may also be arranged with different patterns. As shown in FIG. 1A, the pockets or cavities 12, which hold permanent magnets, are arranged with a V-shape 34. Referring now to FIG. 1B, a plurality of rotor sections 10 may form a rotor 8. The rotor has a circular central opening 14 for accommodating a driveshaft (not shown).

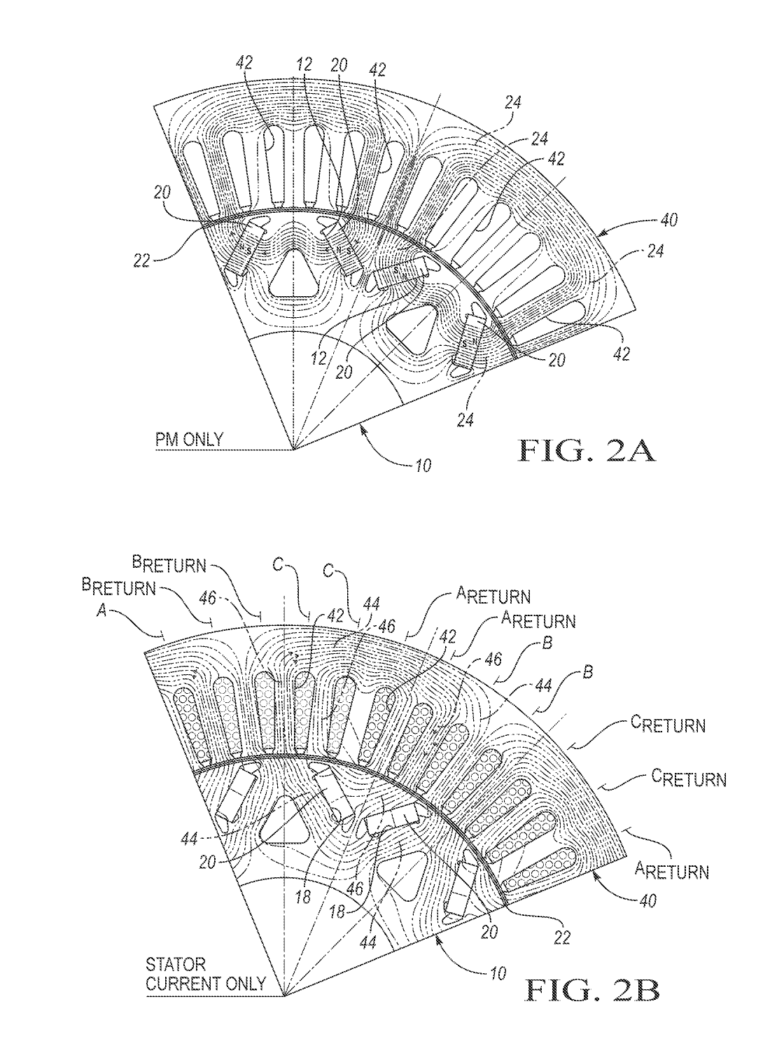

Referring now to FIG. 2A, a portion of the rotor section 10 is shown within a stator 40. The rotor section 10 defines pockets or cavities 12 adapted to hold permanent magnets 20. The permanent magnets 20 are arranged in a V-shape, collectively forming poles. Flux lines 24 emanating from the permanent magnets 20 are shown. The flux lines 24 may permeate through the rotor section 10 and across the airgap 22 into the stator 40. In general, magnetic flux has greater field density when the flux lines 24 are closer together. Redirection of the flux lines 24 may cause an increased magnetic field density in certain locations as shown in FIG. 2A. The stator 40 has windings 42 that are not energized.

Referring to FIG. 2B, a portion of the rotor section 10 is shown within the stator 40. The stator 40 may have windings 42 that are energized. Flux lines 44 may emanate from the windings 42. The flux lines 44 may permeate through the stator 40 and across the airgap 22 into the rotor section 10. A three-phase motor may have windings A, B, and C. The flux lines 44 and flux lines 24 may at least partially interact at position 46 in known fashion to produce torque.

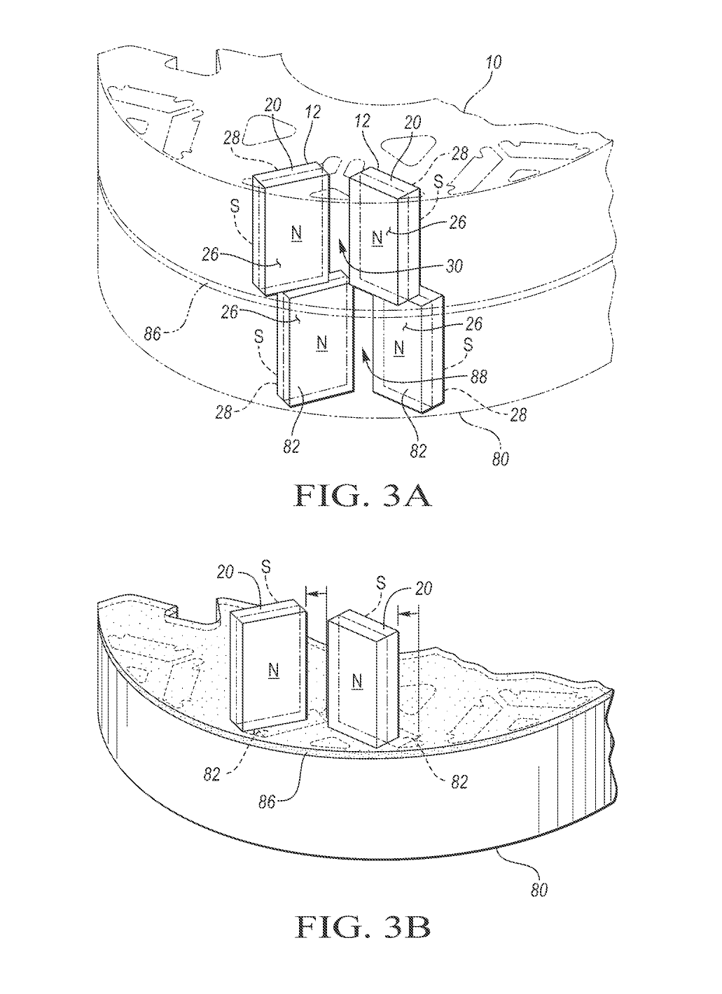

Referring to FIG. 3A, a skewed, adjacent pair of rotor sections 10, 80 may have cavities 12, 84 adapted to hold permanent magnets 20, 82. The permanent magnets 20, 82 may be magnetized such that the north poles 26 face a radially outward direction with respect to the rotor. The permanent magnets 20, 82 may be magnetized such that the south pole 28 faces a generally inward direction. The permanent magnets 20, 82 may be arranged to form magnetic poles 30, 88. The magnetic poles 30, 88 may be skewed or staggered. A rotor layer 86 having low magnetic permeability may be disposed between the rotor sections 10, 80. The rotor layer's outer diameter may fit flush with the outer diameter of the rotor sections 10, 80 or the rotor layer's outer diameter may stop short of the outer diameter of the rotor sections 10, 80. As shown in FIG. 3B, the permanent magnets 20 may be offset from the permanent magnets 82 to form a skewed rotor. A rotor layer 86 having low magnetic permeability may be placed between the rotor sections 10, 80.

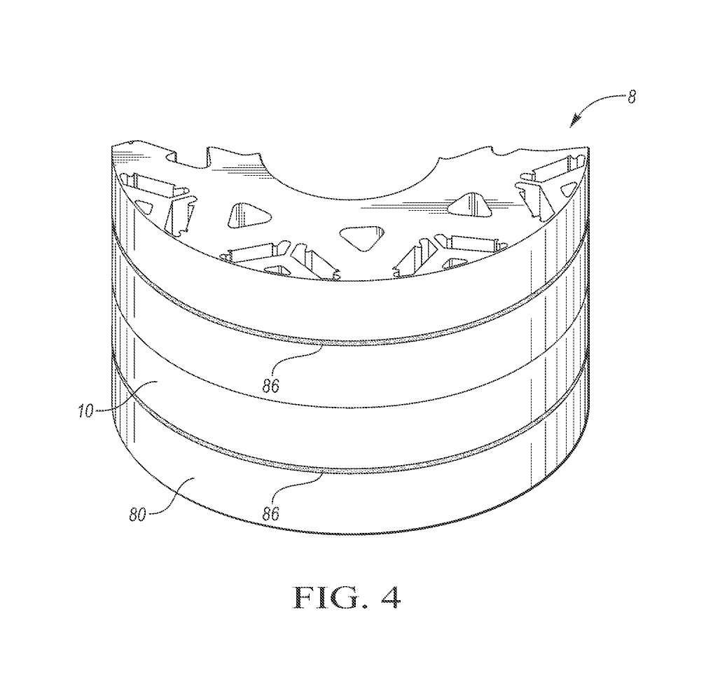

Referring to FIG. 4, a skewed rotor 8 may have a plurality of rotor sections 10, 80. The plurality of rotor sections may be skewed in an ABBA pattern, wherein the letters reference the rotor sections relative skewing and position in the rotor 8 stack. Rotor layers 86 may be interposed between the adjacent AB rotor sections.

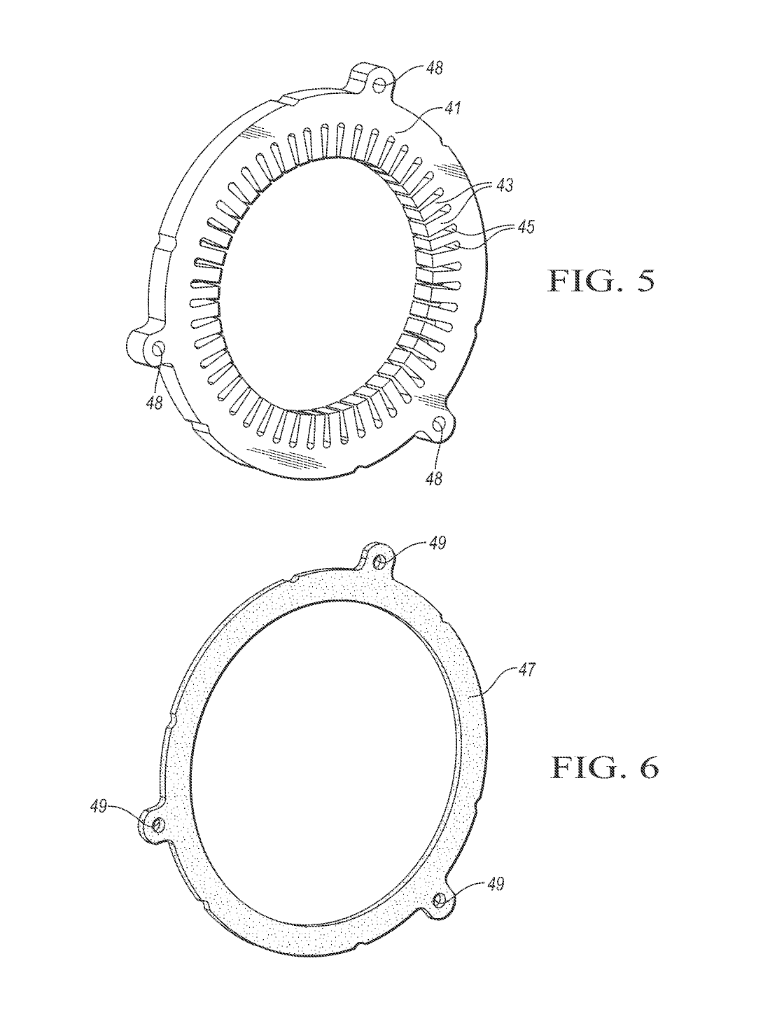

Referring now to FIG. 5, a stator section 41 has a generally annular shape and may be formed by stacking at least one lamination. The laminations may be made of electric steel or other material having low magnetic reluctance. The stator section 41 may have teeth 43 that define stator winding cavities 45. The stator cavities may house windings (as shown in FIG. 2B). The stator section may define fastening cavities 48 configured to enable a fastener to join a stack of stator sections to form a stator.

Now referring to FIG. 6, a portion of an electric machine is shown. A stator layer 47 has a generally annular shape similar to the stator section 41 (not shown). The layer may be made of a material having high magnetic reluctance. The stator layer 47 may include fastening cavities 49 configured to enable the fastener to include the stator layer within the stack of stator sections. The inner diameter or outer diameter of the stator layer 47 may be dissimilar to the stator section 41 to further reduce weight or alter the magnetic field generated. The stator layer 47 may have a thickness similar to the rotor layer 86. The stator layer 47 thickness may vary depending on the desired magnetic field generated. The thickness and type of the stator layer 47 may have a direct impact on the magnetic field. The stator section 41 and stator layer 47 may be stacked to form a stator.

Now referring to FIG. 7, a plurality of stator sections 41 is stacked to form a stator 40. Each stator section 41 has teeth 43 and stator winding cavities 45 to support a set of stator windings. The stator sections may be aligned, as shown. The stator layers 47 may be interposed between stator sections 41 to form the stator 40.

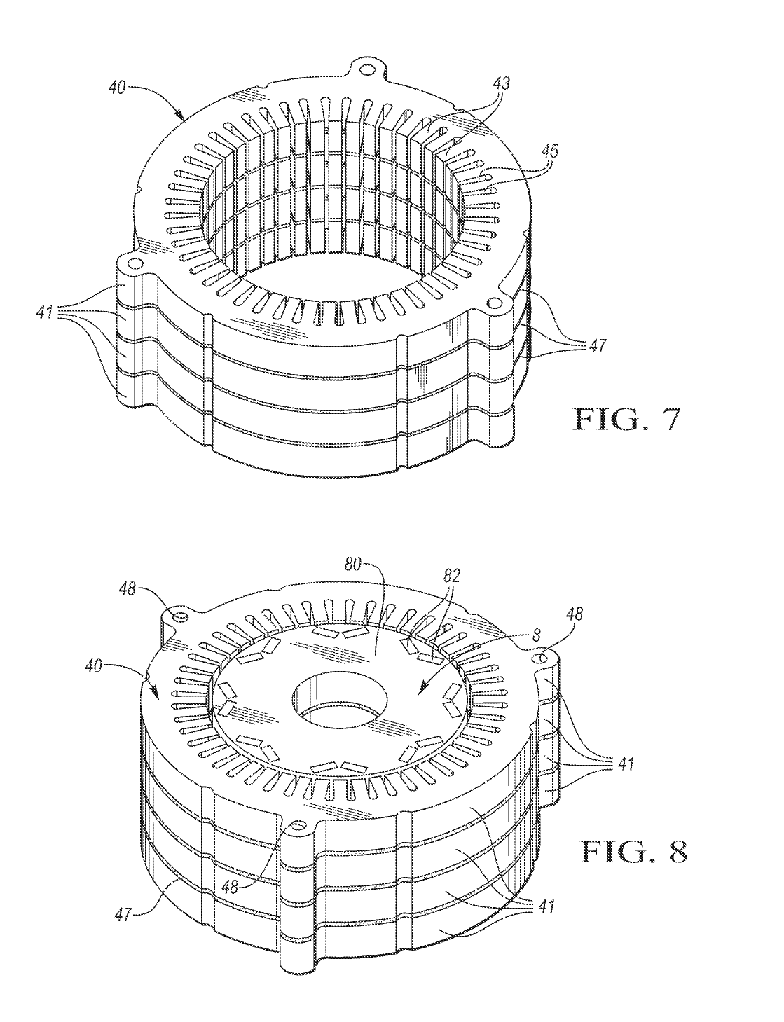

Now referring to FIG. 8, a plurality of stator sections 41 are stacked to form a stator 40. Each stator section 41 has aligned teeth 43 and stator winding cavities 45 to support a set of stator windings. The stator layers 47 may be interposed between stator sections 41 to form the stator 40. The stator 40 may surround a rotor 8 having a plurality of rotor sections 10, 80 (10 not shown) having permanent magnets 20, 82 (20 not shown) arranged therein. Some of the sections are not shown. Each of the rotor sections 10, 80 (10 not shown) may be axially aligned with a corresponding one of the stator sections 41. The rotor layers 86 may be axially aligned with a corresponding stator layer 47.

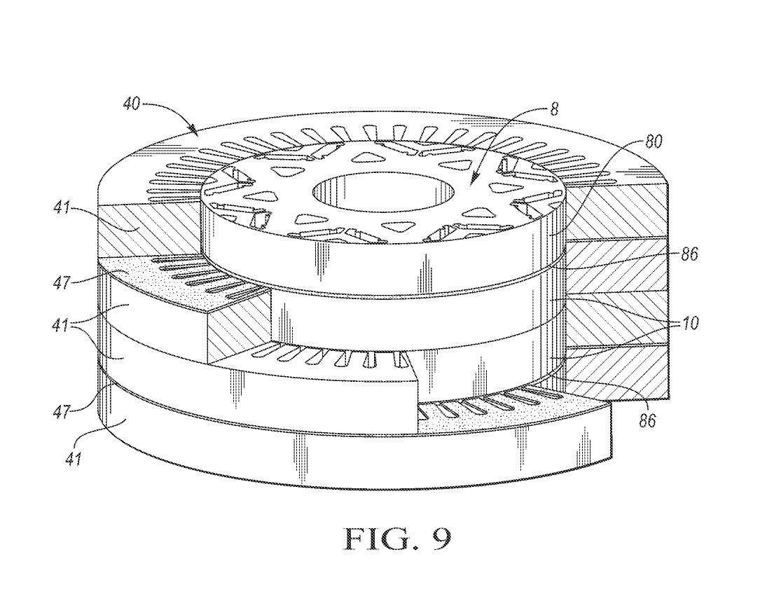

Now referring to FIG. 9, a rotor 8 having rotor sections 10, 80 may be stacked in an ABBA fashion. The adjacent rotor sections 10, 80 having skewed magnetic poles may have rotor layers 86 therein. The rotor 8 may be surrounded by a stator 40. The stator 40 may include stator sections 41 and stator layers 47. Each of the stator sections 41 may be axially aligned and paired with a corresponding one of the rotor sections 10, 80. The stator layers 47 may only be disposed between stator sections 41 having corresponding rotor sections 10, 80 having skewed magnetic poles. Meaning, the stator layers 47 may also have corresponding rotor layers 86.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An electric machine comprising:
a plurality of stator sections each formed from one or more stator laminations stacked to form a stator having windings arranged therein to form magnetic poles and surrounding a rotor; and
a layer interposed between an adjacent pair of the stator sections such that magnetic fields associated with the magnetic poles are aligned axially with corresponding magnetic fields from the rotor.

2. The electric machine of claim 1, wherein the layer is diamagnetic or paramagnetic.

3. The electric machine of claim 2 wherein the rotor includes a plurality of rotor sections each formed from one or more rotor laminations and stacked such that the rotor has skewed magnetic poles, and a diamagnetic or paramagnetic rotor layer interposed between each adjacent pair of the rotor sections that has skewed magnetic poles.

4. The electric machine of claim 3, wherein the layer interposed between an adjacent pair of the stator sections and one of the rotor layers are coplanar.

5. The electric machine of claim 3, wherein a thickness of each of the layers interposed between the adjacent pair of the stator sections and one of the rotor layers is same.

6. The electric machine of claim 2, wherein the layer is polytetrafluoroethylene.

7. The electric machine of claim 2, wherein a thickness of the layer is at least twice an airgap distance between the stator and rotor.

8. The electric machine of claim 7, wherein the thickness is less than four times the airgap distance.

9. An electric machine comprising:
a plurality of stator sections stacked to form a stator;
a plurality of rotor sections each containing permanent magnets arranged in a V-shape and stacked to form a rotor having skewed magnetic poles;
a diamagnetic or paramagnetic rotor layer interposed between an adjacent pair of the rotor sections; and
a diamagnetic or paramagnetic stator layer interposed between an adjacent pair of the stator sections and coplanar with the rotor layer.

10. The electric machine of claim 9, wherein the rotor layer separates the adjacent pair of the rotor sections having the skewed magnetic poles.

11. The electric machine of claim 10, wherein a thickness of each of the rotor and stator layers is same.

12. The electric machine of claim 9, wherein a thickness of the stator layer is at least twice an airgap distance between the stator and rotor.

13. The electric machine of claim 12, wherein the thickness of the stator layer is less than four times the airgap distance.

14. The electric machine of claim 9, wherein the rotor and stator layers are polytetrafluoroethylene.

15. An electric machine comprising:
a rotor including outer sections with aligned poles sandwiching inner sections with aligned poles such that the aligned poles of the inner sections are skewed relative to the aligned poles of the outer sections, and a diamagnetic or paramagnetic rotor layer disposed between each adjacent pair of the inner and outer sections; and
a stator surrounding the rotor having diamagnetic or paramagnetic stator layers coplanar with the diamagnetic or paramagnetic layers disposed between the adjacent pairs of the inner and outer sections.

16. The electric machine of claim 15, wherein a thickness of each of the rotor and stator layers is same.

17. The electric machine of claim 15, wherein the rotor and stator layers are polytetrafluoroethylene.

18. The electric machine of claim 15, wherein a thickness of each of the stator layers is at least twice an airgap distance between the stator and rotor.

19. The electric machine of claim 18, wherein the thickness of each of the stator layers is less than four times the airgap distance.
